(19) United States
(12) Patent Application Publication
(10) Pub. No.: US 2025/0249746 A1
(43) Pub. Date: Aug. 7, 2025

(54) VEHICLE INFORMATION PROVISION SYSTEM, INFORMATION PROVISION METHOD THEREOF, AND VEHICLE INCLUDING SAME

(71) Applicants: Hyundai Motor Company, Seoul (KR); Kia Corporation, Seoul (KR)

(72) Inventor: Jin Ook YOO, Yongin-si (KR)

(73) Assignees: Hyundai Motor Company, Seoul (KR); Kia Corporation, Seoul (KR)

(21) Appl. No.: 18/795,969

(22) Filed: Aug. 6, 2024

(30) Foreign Application Priority Data
Feb. 1, 2024 (KR) 10-2024-0015974

(51) Int. Cl. B60K 35/29; B60K 35/28; G06T 11/60

(52) U.S. Cl. CPC B60K 35/29; B60K 35/28; G06T 11/60; G06T 2200/24

(57) ABSTRACT

A vehicle information provision system, an information provision method thereof, and a vehicle including the same are proposed. The proposed are implemented to strengthen security for vehicle data by synthesizing and outputting data obtained by processing vehicle interface data and the vehicle data based on different system languages. The vehicle information provision system may include a first data reception module for receiving vehicle data, a second data reception module for receiving vehicle interface data and first metadata related to the vehicle data, and a processor for processing the vehicle data and the vehicle interface data based on system languages different from each other and synthesizing the vehicle data based on the first metadata into a user experience (UX) environment generated by processing the vehicle interface data.

### CROSS REFERENCE TO RELATED APPLICATION

The present application claims priority to Korean Patent Application No. 10-2024-0015974, filed on Feb. 1, 2024, the entire contents of which is incorporated herein for all purposes by this reference.

### BACKGROUND OF THE PRESENT DISCLOSURE

### Field of the Present Disclosure

The present disclosure relates to a vehicle information provision system, an information provision method thereof, and a vehicle including the same, which are implemented to strengthen security for vehicle data by synthesizing and outputting data obtained by processing vehicle interface (UX) data and the vehicle data based on system languages different from each other.

### Description of Related art

Infotainment systems for providing information and entertainment are provided in vehicles.

The infotainment system may manage and/or output infotainment information and vehicle data through an interface (UX: user experience) implemented based on a markup language such as HTML5.

In response that vehicle data is managed and/or output through the interface implemented based on the markup language such as HTML5, the vehicle data may be leaked to the outside through methods such as script injection.

Accordingly, there are requirements for a method configured for strengthening security to prevent vehicle data from being leaked to the outside in a process of managing and/or outputting the vehicle data by an entertainment system.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle information provision system, an information provision method thereof, and a vehicle including the same, which are implemented to synthesize vehicle interface (UX) data and vehicle data, which are processed based on system languages different from each other, and output the synthesized data.

Furthermore, in the exemplary embodiment of the present disclosure, another objective of solving the technical problem is to provide a vehicle information provision system, an information provision method thereof, and a vehicle including the same, which are implemented to synthesize and output vehicle data processed through a vehicle programming language-based processing module into a UX environment output by processing vehicle UX data through a markup language-based processing module.

Furthermore, in the exemplary embodiment of the present disclosure, a yet another objective of solving the technical problem is to provide a vehicle information provision system, an information provision method thereof, and a vehicle including the same, which are implemented to provide a vehicle data display area in a UX environment, which is output from a markup language-based processing module, and output vehicle data output from a vehicle programming language-based processing module to the vehicle data display area.

The objectives for solving the technical problem of the present disclosure are not limited to the matters described above, and from the following description, those skilled in the art to which the present disclosure pertains will clearly understand other objectives intended by the present disclosure as well.

As a technical means to achieve the above-described technical problem, there may be provided a vehicle information provision system, an information provision method thereof, and a vehicle including the same, which are implemented to strengthen security for vehicle data by processing vehicle interface (UX) data and the vehicle data based on system languages different from each other.

According to the exemplary embodiment of the present disclosure, there is provided a vehicle information provision system, including: a first data reception module for receiving vehicle data; a second data reception module for receiving vehicle interface (UX: user experience) data and first metadata related to the vehicle data; and a processor for processing the vehicle data and the vehicle UX data based on system languages different from each other and synthesizing the vehicle data based on the first metadata into a UX environment generated by processing the vehicle UX data.

According to the exemplary embodiment of the present disclosure, the processor may include: a first data processing module for processing the vehicle data in a vehicle programming language; a second data processing module for processing the vehicle UX data based on a markup language, to generate the UX environment; and a synthesis module for synthesizing the vehicle data into the UX environment based on the first metadata.

According to the exemplary embodiment of the present disclosure, the first data reception module may receive identification data related to the vehicle data, and the first data processing module may be configured for processing the vehicle data and the identification data and generates the identification data-matched vehicle data to be stored in a memory.

According to the exemplary embodiment of the present disclosure, the second data reception module may receive second metadata related to the vehicle UX data, and the second data processing module may be configured for processing the vehicle UX data based on the second metadata and generates the UX environment.

According to the exemplary embodiment of the present disclosure, the second data processing module may allocate a vehicle data display area on the UX environment based on the first metadata, and the synthesis module may synthesize the vehicle data into the vehicle data display area.

According to the exemplary embodiment of the present disclosure, the synthesis module may search the memory for the vehicle data corresponding to the identification data included in the first metadata and synthesizes the searched vehicle data into the UX environment.

According to the exemplary embodiment of the present disclosure, there is provided a vehicle information provision method, including: receiving vehicle data; receiving vehicle interface (UX: user experience) data and first metadata related to the vehicle data; processing the vehicle data based on a first system language; processing the vehicle UX data based on a second system language; and synthesizing the vehicle data based on the first metadata into a UX environment generated by processing the vehicle UX data.

According to the exemplary embodiment of the present disclosure, the first system language may be a vehicle programming language, and the second system language may be a markup language.

According to the exemplary embodiment of the present disclosure, the receiving of the vehicle data may further receive identification data related to the vehicle data, and the processing of the vehicle data may include processing the vehicle data and the identification data and generating the identification data-matched vehicle data to be stored in a memory.

According to the exemplary embodiment of the present disclosure, the receiving of the vehicle UX data and the first metadata related to the vehicle data may further receive second metadata related to the vehicle UX data, and the processing of the vehicle UX data based on the second system language may include processing the vehicle UX data based on the second metadata and generating the UX environment.

According to the exemplary embodiment of the present disclosure, the processing of the vehicle UX data based on the second system language may include allocating a vehicle data display area on the UX environment based on the first metadata, and the synthesizing of the vehicle data may include synthesizing the vehicle data into the vehicle data display area.

According to the exemplary embodiment of the present disclosure, the synthesizing of the vehicle data may include searching the memory for the vehicle data corresponding to the identification data included in the first metadata and synthesizing the searched vehicle data into the UX environment.

According to the exemplary embodiment of the present disclosure, there is provided a vehicle, including: a vehicle data provision device configured to provide vehicle data; a vehicle interface provision device configured to provide vehicle interface (UX: user experience) data and metadata related to the vehicle data; and a vehicle information provision system including a processor and configured to process the vehicle data and the vehicle UX data based on system languages different from each other and synthesize the vehicle data based on first metadata into a UX environment generated by processing the vehicle UX data.

Specific details according to various examples of the present disclosure other than the means for solving the above-described problem are included in the description and drawings below.

According to the exemplary embodiment of the present disclosure, vehicle interface (UX) data and vehicle data may be processed through paths different from each other.

Furthermore, the vehicle data processed through the vehicle programming language-based processing module may be synthesized and output into a UX environment output by processing the vehicle interface data through the markup language-based processing module.

Accordingly, since the vehicle data is not processed by the markup language-based processing module, leakage of the vehicle data which may occur during markup language-based processing may be prevented and security for the vehicle data may be strengthened.

Furthermore, since the vehicle data is displayed through the markup language-based UX environment as in the conventional method, the security for the vehicle data may be structurally strengthened while maintaining the advantages of the markup language-based UX environment as it is.

The effects of the present disclosure are not limited to the above-described effects, and other effects not described above will be clearly understood by those skilled in the art from the description of the claims below.

Because the contents of the problem to be solved, problem solution, and effects, which are described above, do not specify the essential characteristics of the claims, the scope of the claims is not limited by the matters described in the contents of the present disclosure.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating a vehicle 1 including a vehicle information provision system 100 according to an exemplary embodiment of the present disclosure.

FIG. 2 is a view exemplarily illustrating a configuration of the vehicle information provision system 100 according to the exemplary embodiment of the present disclosure.

FIG. 3 is a view exemplarily illustrating an example in which vehicle data and a UX environment are synthesized by the vehicle information provision system 100 according to the exemplary embodiment of the present disclosure.

FIG. 4 is a view exemplarily illustrating an information provision method according to the exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Advantages and features of the present disclosure and a method of achieving the advantages and features thereof will become apparent with reference to the exemplary embodiments described below in detail together with the accompanying drawings. However, the present disclosure is not limited to the exemplary embodiments included below, but will be implemented in a variety of different forms. These exemplary embodiments are provided only to complete the present disclosure of the present disclosure and to completely inform the scope of the present disclosure to those skilled in the art to which the present disclosure pertains, and the present disclosure is only defined by the scope of the claims.

The shapes, sizes, ratios, angles, numbers, and the like included in the accompanying drawings for describing the exemplary embodiment of the present disclosure are merely examples, and the present disclosure is not limited thereto. Like reference numerals generally denote like components throughout the present disclosure. Furthermore, in describing the present disclosure, when it is determined that a detailed description of a related known technology may unnecessarily obscure the subject matter of the present disclosure, the detailed description thereof will be omitted. The terms such as “including”, “having”, and “consist of” used herein are generally intended to allow other components to be added unless the terms are used with the term “only”. Cases where a component is expressed in the singular include cases including the plural, unless specifically stated otherwise.

In interpreting components, even when there is no separate explicit description of an error range, it is interpreted as including the error range.

When the relation of a time sequential order is described by use of the terms such as “after”, “continuously to”, “next to”, and “before”, the order may not be continuous unless the terms are used with the term “immediately” or “directly”.

Although the terms first, second, etc. may be used herein to describe various components, these components should not be limited by these terms. These terms are only used to distinguish one component from another component. Therefore, the first component described herein below may be the second component within the technical idea of the present disclosure.

When the components of the present disclosure are described, terms such as first, second, A, B, (a), or (b) may be used. Because these terms are provided merely for distinguishing the components from each other, the nature, sequence, order, or the number of the corresponding components is not limited thereto. When a component is described as being “connected”, “coupled”, or “interfaced” to another component, that component may be directly connected or interfaced to that another component, but it should be understood that other components may also be “interposed” between each component which is indirectly connected or interfaced unless specifically stated otherwise,

“At least one” shall be understood to include any combination of one or more of associated components. For example, “at least one of the first, second, and third components” means not only the first, second, or third component are included, but also combination of any two or more of the first, second, and third components are included.

Features of various exemplary embodiments of the present specification may be partially or overall coupled to or combined with each other, and may be variously interoperated with each other and driven technically. Each of the exemplary embodiments of the present disclosure may also be conducted independently from each other, and may be conducted together with associative relationships.

Scales of the components shown in the drawings have scales different from the actual scales for convenience of description, and thus are not limited to the scales shown in the drawings.

Hereinafter, a vehicle information provision system, an information provision method thereof, and a vehicle including the same according to the exemplary embodiment of the present disclosure will be described with reference to the appended drawings.

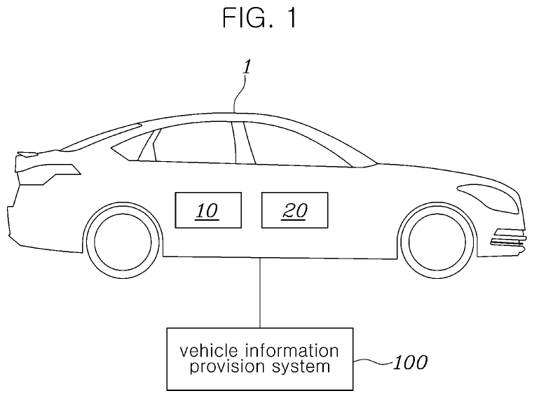

FIG. 1 is a view exemplarily illustrating a vehicle 1 including a vehicle information provision system 100 according to an exemplary embodiment of the present disclosure.

Referring to FIG. 1, the vehicle 1 may include the vehicle information provision system 100 according to the exemplary embodiment of the present disclosure.

For example, the vehicle 1 may include an electric vehicle (EV), a hybrid electric vehicle (HEV), a plug-in hybrid electric vehicle (PHEV), a hydrogen fuel cell electric vehicle (FCEV), etc and the type of the vehicle 1 is not limited thereto.

The vehicle 1 may be equipped with a data provision device for providing data required for the operation of the vehicle information provision system 100.

According to the exemplary embodiment of the present disclosure, the data provision device may include: a vehicle data provision device 10 for providing vehicle data; and a vehicle interface provision device 20 for providing vehicle interface data (hereinafter, vehicle UX data), but the type of data provision device is not limited thereto.

The vehicle data provision device 10 may provide identification data for identifying vehicle data along with the vehicle data. For example, the vehicle data provision device 10 may include a sensor for sensing an internal or external temperature of the vehicle, a sensor for measuring a speed of the vehicle, sensor for measuring a driving distance of the vehicle, etc.

According to the exemplary embodiment of the present disclosure, the identification data related to the vehicle data may be used when the vehicle data and the vehicle UX data are synthesized.

For example, vehicle data may include data related to a vehicle condition, a vehicle interior environment, a vehicle external environment, etc. For example, the vehicle data may include vehicle speed, vehicle mileage, vehicle interior temperature, vehicle external temperature, etc., but the type of data included in the vehicle data is not limited thereto.

For example, vehicle UX data may be data for defining attributes of vehicle data. That is, the vehicle UX data may refer to data to help users know what data is related to the vehicle data.

For example, in response that vehicle data is speed, vehicle UX data may include image data (“SPEED”), unit data (“km/h”), etc. To indicate that the vehicle data is data related to the speed.

For example, in response that vehicle data is a driving distance, vehicle UX data may include image data (“DRIVING LENGTH”), unit data (“km”), etc. To indicate that the vehicle data is data related to the driving distance.

For example, in response that vehicle data is a temperature inside a vehicle, vehicle UX data may include image data (“In-Vehicle Temperature”), unit data (“° C.”), etc. To indicate that the vehicle data is data related to the temperature inside the vehicle.

In the present way, vehicle UX data may be data for providing a fundamental display environment required for the vehicle 1 to perform an infotainment function, and the vehicle UX data may be preset in the vehicle 1 when the infotainment function in the vehicle 1 is designed.

According to the exemplary embodiment of the present disclosure, the vehicle interface provision device 20 may provide metadata related to vehicle UX data. Furthermore, the vehicle interface provision device 20 may provide metadata related to vehicle data. For example, the vehicle interface provision device 20 may include infotainment system.

For example, the metadata related to the vehicle UX data may include display position data, display format data, additional data, etc. of the vehicle UX data. Furthermore, the metadata related to the vehicle data may include identification data, display position data, display format data, additional data, etc. of the vehicle data.

The vehicle information provision system 100 may provide information based on data provided from the data provision device.

According to the exemplary embodiment of the present disclosure, the vehicle information provision system 100 may synthesize and provide vehicle data provided from the vehicle data provision device 10 and vehicle UX data provided from the vehicle interface provision device 20.

The vehicle information provision system 100 may be configured for processing the vehicle data and vehicle UX data based on system languages different from each other.

The vehicle information provision system 100 may synthesize the vehicle data and vehicle UX data, which are processed based on the system languages different from each other, to be output through a display device.

The vehicle information provision system 100 may synthesize vehicle data, into a UX environment generated by processing vehicle UX data, to be output through the display device.

The vehicle information provision system 100 may synthesize vehicle data into the UX environment based on the metadata related to the vehicle data.

For example, the vehicle information provision system 100 according to the exemplary embodiment of the present disclosure may be configured as a part of an infotainment system, and the infotainment system may perform an information provision method according to the exemplary embodiment of the present disclosure.

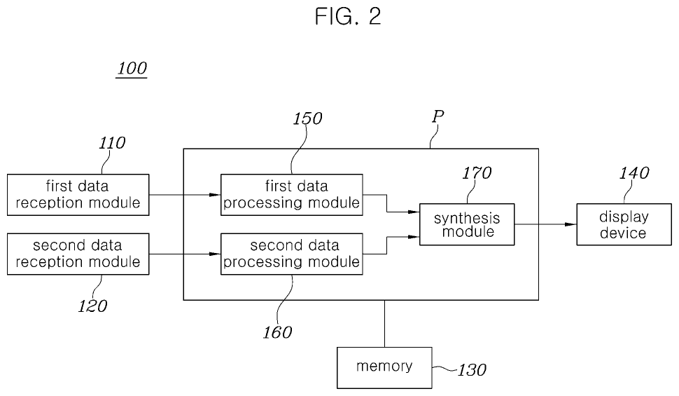

FIG. 2 is a view exemplarily illustrating a configuration of the vehicle information provision system 100 according to the exemplary embodiment of the present disclosure.

Referring to FIG. 1 and FIG. 2, the vehicle information provision system 100 according to the exemplary embodiment of the present disclosure may include a first data reception module 110, a second data reception module 120, a memory 130, a display device 140, and a processor P, and the configuration of the vehicle information provision system 100 is not limited thereto.

The first data reception module 110 may receive vehicle data provided from the vehicle data provision device 10.

The second data reception module 120 may receive vehicle UX data provided from the vehicle interface provision device 20.

The vehicle data received by the first data reception module 110 and the vehicle UX data received by the second data reception module 120 may be provided to the processor P.

Each of the first data reception module 110 and the second data reception module 120 may include a module for performing internal vehicle communication, for example, a Controller Area Network (CAN) communication, a Local Interconnect Network (LIN) communication, and a Local Area Network (LAN) communication.

The memory 130 may store various algorithms, data, etc., which are required for the processor P to operate.

The memory 130 may include a volatile memory and/or a non-volatile memory. The volatile memory may include a dynamic random access memory (DRAM), a static RAM (SRAM), a synchronous DRAM (SDRAM), a phase-change RAM (PRAM), a magnetic RAM (MRAM), a resistive RAM (RRAM), a ferroelectric RAM (FeRAM), etc. The non-volatile memory may include a read only memory (ROM), a programmable ROM (PROM), an electrically programmable ROM (EPROM), an electrically erasable and programmable ROM (EEPROM), a flash memory, etc.

According to the exemplary embodiment of the present disclosure, the memory 130 may store an algorithm for implementing the information provision method according to the exemplary embodiment of the present disclosure. For example, the memory 130 may store an algorithm for processing data, an algorithm for synthesizing data, etc., which are performed by the processor P.

The display device 140 may display information provided from the processor P. For example, the display device 140 may be implemented with a liquid crystal display (LCD) module, an organic light emitting diodes (OLED) module, etc., and the type of the display device 140 is not limited thereto.

For example, the display device 140 may include a head-up display, an audio video navigation (AVN) display, etc.

The processor P may perform the algorithms stored in the memory 130. For example, the processor P may be configured for processing the received data and the data stored in the memory 130. The processor P may execute computer-readable codes (e.g., an algorithm) stored in the memory 130 and instructions triggered by the processor P.

The processor P may be a data processing device implemented in hardware including a circuit with a physical structure for executing desired operations. For example, the desired operations may include code or instructions included in a program.

For example, the data processing device implemented in hardware may include a microprocessor, a central processing unit, a processor core, a multi-core processor, a multiprocessor, an application-specific integrated circuit (ASIC), and a field programmable gate array (FPGA).

According to the exemplary embodiment of the present disclosure, the processor P may synthesize vehicle data provided from the vehicle data provision device 10 and vehicle UX data provided from the vehicle interface provision device 20 and provide the synthesized data.

The processor P may synthesize the vehicle data and vehicle UX data, which are processed based on system languages different from each other, to be output through the display device 140.

The processor P may synthesize vehicle data into a UX environment generated by processing vehicle UX data based on the metadata related to the vehicle data.

According to the exemplary embodiment of the present disclosure, the processor P may include a first data processing module 150, a second data processing module 160, and a synthesis module 170.

The first data processing module 150 may receive vehicle data and identification data related to the vehicle data, which are provided from the vehicle data provision device 10, and may output vehicle data matched with the identification data.

For example, the identification data-matched vehicle data output by the first data processing module 150 may be stored in the memory 130.

According to the exemplary embodiment of the present disclosure, the first data processing module 150 may be configured for processing the vehicle data and identification data based on the vehicle programming language.

The second data processing module 160 may receive vehicle UX data and metadata, which are provided from the vehicle interface provision device 20. Here, the metadata may include the metadata related to the vehicle UX data and the metadata related to the vehicle data.

According to the exemplary embodiment of the present disclosure, the second data processing module 160 may be configured to generate and output a UX environment based on the vehicle UX data and the metadata related to the vehicle UX data.

According to the exemplary embodiment of the present disclosure, the second data processing module 160 may be configured for processing the vehicle UX data and the metadata related to the vehicle UX data based on the markup language.

According to the exemplary embodiment of the present disclosure, the second data processing module 160 may allocate a vehicle data display area on the UX environment based on the metadata related to the vehicle data.

That is, the UX environment generated by the second data processing module 160 includes the vehicle data display area.

The second data processing module 160 may provide the UX environment and the metadata related to the vehicle data to the synthesis module 170.

The synthesis module 170 according to the exemplary embodiment of the present disclosure may synthesize the vehicle data into the UX environment and displays the synthesized data on the display device 140 based on the UX environment and the metadata related to the vehicle data, which are provided by the second data processing module 160.

The synthesis module 170 may search the memory 130 for the vehicle data corresponding to identification data of the vehicle data included in the metadata related to the vehicle data, and synthesize the searched vehicle data into the UX environment.

The synthesis module 170 may synthesize the vehicle data into the UX environment based on display position data of the vehicle data included in the metadata related to the vehicle data.

The synthesis module 170 may synthesize the vehicle data into the UX environment based on display format data of the vehicle data included in the metadata related to the vehicle data.

According to the exemplary embodiment of the present disclosure, the synthesis module 170 may display a default user interface (UI) which is pre-stored in the memory 130 in response that the second data processing module 160 does not successfully receive the metadata required to implement the UX environment.

According to the exemplary embodiment of the present disclosure, the synthesis module 170 may display a default UI which is pre-stored in the memory 130 in response that the second data processing module 160 is in an abnormal state.

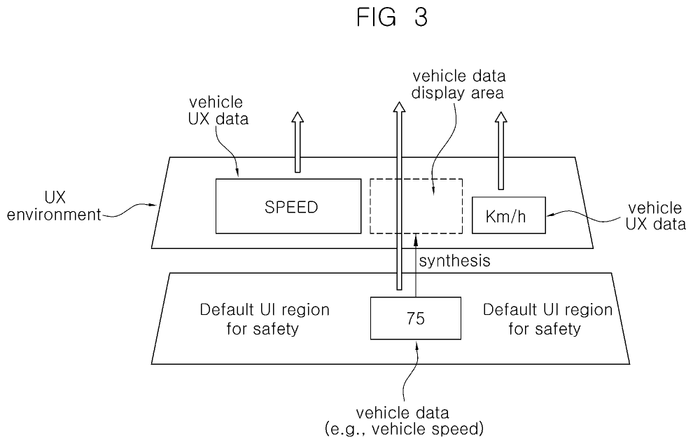

FIG. 3 is a view exemplarily illustrating an example in which vehicle data and a UX environment are synthesized by the vehicle information provision system 100 according to the exemplary embodiment of the present disclosure, and illustrates a case where a speed of a vehicle is provided.

As shown in FIG. 3, the vehicle information provision system 100 may synthesize the speed, i.e., the vehicle data, into a vehicle data display area in the UX environment including vehicle UX data.

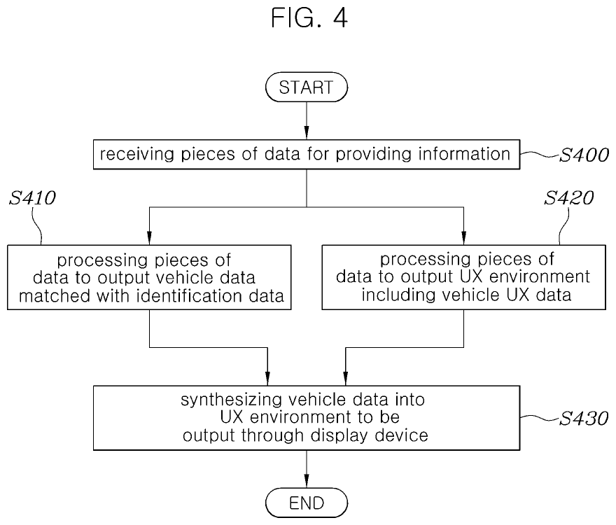

FIG. 4 is a view exemplarily illustrating an information provision method according to the exemplary embodiment of the present disclosure.

The step-by-step operations shown in FIG. 4 may be performed by the vehicle information provision system 100 described with reference to FIG. 1, FIG. 2, and FIG. 3.

Referring to FIG. 1, FIG. 2, FIG. 3, and FIG. 4, in step S400, the vehicle information provision system 100 may receive vehicle data and vehicle UX data.

In step S400, the vehicle information provision system 100 may receive the vehicle data provided by a vehicle data provision device 10 through a first data reception module 110, and receive the vehicle UX data provided by a vehicle interface provision device 20 through a second data reception module 120.

In step S400, the vehicle information provision system 100 may receive identification data related to the vehicle data along with the vehicle data from the vehicle data provision device 10.

In step S400, the vehicle information provision system 100 may receive metadata related to the vehicle UX data and metadata related to the vehicle data, along with the vehicle UX data, from the vehicle interface provision device 20.

Thereafter, in step S410, the vehicle information provision system 100 may be configured for processing first vehicle data and identification data by use of a first data processing module 150, to output vehicle data matched with the identification data.

In step S410, the first data processing module 150 may be configured for processing the vehicle data and the identification data based on the vehicle programming language.

Furthermore, in step S420, the vehicle information provision system 100 may be configured for processing the vehicle UX data and the metadata related to the vehicle UX data by use of a second data processing module 160, to output a UX environment including the vehicle UX data.

In step S420, the second data processing module 160 may be configured for processing the vehicle UX data and the metadata related to the vehicle UX data based on the markup language.

In step S420, the second data processing module 160 may allocate a vehicle data display area on the UX environment based on the metadata related to the vehicle data.

Thereafter, in step S430, the vehicle information provision system 100 may synthesize the vehicle data into the UX environment by use of a synthesis module 170 and output the synthesized image through a display device 140. Because the information provision system 100 synthesizes and outputs vehicle data processed based on a vehicle programming language into a UX environment, security for vehicle data can be enhanced by preventing leakage to the outside that may occur when vehicle data is processed based on a markup language.

In step S430, the synthesis module 170 may synthesize the vehicle data in the vehicle data display area allocated on the UX environment.

In step S430, the synthesis module 170 may search a memory 130 for the vehicle data corresponding to the identification data of the vehicle data included in the metadata related to the vehicle data, and synthesize the searched vehicle data into the UX environment.

In step S430, the synthesis module 170 may synthesize the vehicle data into the UX environment based on display position data of the vehicle data included in the metadata related to the vehicle data.

The control device may be at least one microprocessor operated by a predetermined program which may include a series of commands for carrying out the method included in the aforementioned various exemplary embodiments of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

Hereinafter, the fact that pieces of hardware are coupled operably may include the fact that a direct and/or indirect connection between the pieces of hardware is established by wired and/or wirelessly.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle information provision system, the system comprising:
a first data reception module configured to receive vehicle data;
a second data reception module configured to receive vehicle interface data and first metadata related to the vehicle data; and
a processor operably connected to the first data reception module and the second data reception module and configured to process the vehicle data and the vehicle interface data based on different system languages and to synthesize the vehicle data based on the first metadata into a user experience (UX) environment generated by processing the vehicle interface data.

2. The vehicle information provision system of claim 1, wherein the processor is further configured to output synthesized data, through a display device.

3. The system of claim 1,
wherein the different system languages include a vehicle programming language and a markup language, and
wherein the processor includes:
a first data processing module configured to process the vehicle data based on the vehicle programming language;
a second data processing module configured to process the vehicle interface data based on the markup language, to generate the UX environment; and
a synthesis module configured to synthesize the vehicle data into the UX environment based on the first metadata.

4. The system of claim 3,
wherein the first data reception module is further configured to receive identification data related to the vehicle data, and
wherein the first data processing module is further configured to process the vehicle data and the identification data and generate the identification data-matched vehicle data to be stored in a memory.

5. The system of claim 3,
wherein the second data reception module is further configured to receive second metadata related to the vehicle interface data, and
wherein the second data processing module is further configured to process the vehicle interface data based on the second metadata and to generate the UX environment.

6. The system of claim 3,
wherein the second data processing module is further configured to allocate a vehicle data display area on the UX environment based on the first metadata, and
wherein the synthesis module is further configured to synthesize the vehicle data into the vehicle data display area.

7. The system of claim 6, wherein the synthesis module is further configured to output the synthesized vehicle data on a display device.

8. The system of claim 4, wherein the synthesis module is further configured to search the memory for the vehicle data corresponding to the identification data comprised in the first metadata and synthesize the searched vehicle data into the UX environment.

9. A vehicle information provision method, the method comprising:
receiving vehicle data;
receiving vehicle interface data and first metadata related to the vehicle data;
processing, by a processor, the vehicle data based on a first system language;
processing, by a processor, the vehicle interface data based on a second system language; and
synthesizing, by a processor, the vehicle data based on the first metadata into a user experience (UX) environment generated by processing the vehicle interface data.

10. The method of claim 9, further including:
outputting, by the processor, synthesized data, through a display device.

11. The method of claim 9,
wherein the first system language is a vehicle programming language, and
wherein the second system language is a markup language.

12. The method of claim 9,
wherein the receiving of the vehicle data includes receiving identification data related to the vehicle data, and
wherein the processing of the vehicle data includes processing the vehicle data and the identification data and generating identification data-matched vehicle data to be stored in a memory.

13. The method of claim 9,
wherein the receiving of the vehicle interface data and the first metadata related to the vehicle data includes receiving second metadata related to the vehicle interface data, and
wherein the processing of the vehicle interface data based on the second system language includes processing the vehicle interface data based on the second metadata and generating the UX environment.

14. The method of claim 9,
wherein the processing of the vehicle interface data based on the second system language includes allocating a vehicle data display area on the UX environment based on the first metadata, and
wherein the synthesizing of the vehicle data includes synthesizing the vehicle data into the vehicle data display area.

15. The method of claim 14, further including:
outputting the synthesized vehicle data on a display device.

16. The method of claim 12, wherein the synthesizing of the vehicle data includes searching the memory for the vehicle data corresponding to the identification data comprised in the first metadata and synthesizing the searched vehicle data into the UX environment.

17. A vehicle, comprising:
a vehicle data provision device configured to provide vehicle data;
a vehicle interface provision device configured to provide vehicle interface data and metadata related to the vehicle data; and
a vehicle information provision system including a processor operably connected to the first data reception module and the second data reception module and configured to process the vehicle data and the vehicle interface data based on system languages different from each other, synthesize the vehicle data based on first metadata into a user experience (UX) environment generated by processing the vehicle interface data and output synthesized data through a display unit.
